(19) United States
(12) Patent Application Publication
(10) Pub. No.: US 2024/0288647 A1
(43) Pub. Date: Aug. 29, 2024

(54) FIBER OPTIC CABLE

(71) Applicant: NIPPON TELEGRAPH AND TELEPHONE CORPORATION, Tokyo (JP)

(72) Inventors: Akira SAKURAI, Musashino-shi, Tokyo (JP); Hiroaki TANIOKA, Musashino-shi, Tokyo (JP); Shigekatsu TETSUTANI, Musashino-shi, Tokyo (JP); Yusuke YAMADA, Musashino-shi, Tokyo (JP); Masashi KIKUCHI, Musashino-shi, Tokyo (JP)

(73) Assignee: NIPPON TELEGRAPH AND TELEPHONE CORPORATION, Tokyo (JP)

(21) Appl. No.: 18/570,957

(22) PCT Filed: Jun. 18, 2021
(86) PCT No.: PCT/JP2021/023183

§ 371 Date: Dec. 15, 2023

(51) Int. Cl. G02B 6/44

(52) U.S. Cl. CPC G02B 6/4431

(57) ABSTRACT

In order to achieve the above-mentioned object, an optical fiber cable according to the present disclosure includes an optical fiber core wire, a sheath covering the optical fiber core wire, three or more anti-tension members inside the sheath, arranged along a longitudinal axis of the optical fiber core wire, and a tear string having an outer periphery a part of which is located outside an outer circumscribed lines of outer peripheries of the three or more anti-tension members in certain cross-sections perpendicular to a longitudinal direction of the sheath, and a part of which comes in contact with an inner periphery of the sheath or is located inside the inner periphery of the sheath in a cross-section perpendicular to the longitudinal direction of the sheath.

### TECHNICAL FIELD

The present disclosure relates to an optical fiber cable having a tear string provided in the optical fiber cable and used for tearing.

### BACKGROUND ART

At present, optical fibers are used in a communication network for providing multimedia services. Specifically, an optical fiber cable in which a sheath is applied to bundled optical fiber core wires is used. Conventionally, an optical fiber cable has a structure in which a groove type slot rod is provided and the optical fiber core wire is housed in the groove, but for the purpose of downsizing diameter, a non-slot type optical fiber cable without slot rod is used (for example, Patent Literature 1).

FIG. 1 is a cross-section of a non-slot type optical fiber cable 1, in which 11 denotes a sheath, 12 denotes an anti-tension member, 13 denotes a string for tearing the sheath (hereinafter, “the string for tearing the sheath” is abbreviated as a “tear string”), and 14 denotes optical fiber core wire.

The anti-tension member 12 is embedded in the sheath 11 in parallel with the longitudinal direction of the optical fiber cable 1. The anti-tension member 12 protects the optical fiber core wire 14 from the tension in the longitudinal direction acting on the optical fiber cable 1, and is made of a member such as a steel wire or a fiber-reinforced plastic, and has a thickness capable of exhibiting sufficient rigidity. The anti-tension member 12 may be composed of a plurality of members (see, for example, Patent Literature 2).

The tear string 13 for easily tearing the sheath and taking out the optical fiber core wire 14 in the optical fiber cable is also embedded in the sheath 11, and the tear string 13 can be exposed and taken out by cutting out the sheath with a cutter or the like.

### CITATION LIST

### Patent Literature

[PTL 1] Japanese Patent No. 4619424 (NTT)
[PTL 2] Japanese Laid-Open Patent Application Publication No. 2015-166806 (NTT)

### SUMMARY OF INVENTION

### Technical Problem

The anti-tension member 12 is essential for protecting the optical fiber cable 1 and the optical fiber core wire 14. However, the anti-tension member 12 prevents itself from downsizing the cable diameter due to its thickness, and the anti-tension member 12 disposed along an asymmetric position in the optical fiber cable 1 would be a factor causing the directivity of bending, and the distribution property of the optical fiber cable is lowered. In contrast to this, as shown in the Patent Literature 2, a plurality of anti-tension members are disposed along a symmetric position, so that the diameter of each of the anti-tension members can be small and the directivity of bending can be relieve.

On the other hand, regarding the plurality of anti-tension members 12 as in the Patent Literature 2, in cutting out the sheath 11 with a cutter or the like, the cutter contacts the anti-tension member 12 before reaching the tear string 13, which becomes difficult to take out the tear string 13. In this case, the tear string 13 cannot be used for tearing the sheath 11, and it is necessary to directly insert a sharp tool into the housing part of the optical fiber core wire 14, so there may be not only a fear of damaging the optical fiber core wire 14, but also a need of long time for tearing work.

For solving the above-mentioned problems, an object of the present disclosure is to provide an optical fiber cable for exposing a tear string prior to an anti-tension member in cutting out a sheath having three or more anti-tension members with a cutter or the like.

### Solution to Problem

In order to achieve the above-mentioned object, the optical fiber cable of the present disclosure has a tear string, peripheral to the anti-tension member, in the longitudinal direction inside the sheath.

Specifically, an optical fiber cable according to the present disclosure includes an optical fiber core wire, a sheath covering the optical fiber core wire, three or more anti-tension members inside the sheath, arranged along a longitudinal axis of the optical fiber core wire, and a tear string having an outer periphery a part of which is located outside outer circumscribed lines of outer peripheries of the three or more anti-tension members in certain cross-sections perpendicular to a longitudinal direction of the sheath, and a part of which comes in contact with an inner periphery of the sheath or is located inside the inner periphery of the sheath in a cross-section perpendicular to the longitudinal direction of the sheath.

For example, in the optical fiber cable according to the present disclosure, the outer circumscribed lines of the three or more anti-tension members are peripheral to the inner periphery of the sheath.

For example, in the optical fiber cable according to the present disclosure, the tear string is composed of a plurality of strings.

For example, in the optical fiber cable according to the present disclosure, the tear string has a structure in which the plurality of strings are twisted together.

For example, in the optical fiber cable according to the present disclosure, the tear string has a structure in which the plurality of strings are braided together.

For example, in the optical fiber cable according to the present disclosure, the tear string has a structure in which the plurality of strings are bonded.

For example, in the optical fiber cable according to the present disclosure, the tear string has a structure in which at least one string is linearly arranged, and at least one string is arranged in a wave shape repeating contact with and separation from the string linearly arranged (hereinafter, being abbreviated as “linear string”); and the string arranged in the wave shape has a part, in contact with the linear string, adhered or welded and located inside the outer circumscribed lines, and a part, separating from the linear string, located outside the outer circumscribed lines.

For example, in the optical fiber cable according to the present disclosure, in the sheath, the sheath thickness of the part in which the tear string is arranged is thinner than the sheath thickness of the part in which the tear string is not arranged.

Note that, each of the above-mentioned inventions can be combined as much as possible.

### Advantageous Effects of Invention

According to the present disclosure, the optical fiber cable can be provided for exposing the tear string prior to the anti-tension member in cutting out the sheath having the three or more anti-tension members with a cutter or the like.

### BRIEF DESCRIPTION OF DRAWINGS

FIG. 1 is an example of a cross-section of a non-slot type optical fiber cable.

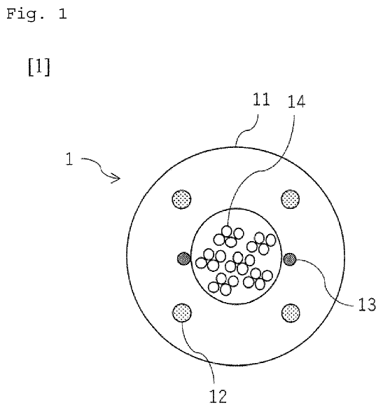

FIG. 2 is an example of a cross-section of a non-slot type optical fiber cable according to the present invention.

FIG. 3 is an example of a cross-section in the vicinity of a tear string of an optical fiber cable according to the present invention.

FIG. 4 is an example of a cross-section in the vicinity of a tear string of an optical fiber cable according to the present invention.

FIG. 5 is an example of a cross-section in the vicinity of a tear string of an optical fiber cable according to the present invention.

FIG. 6 is an example of a cross-section of an optical fiber cable in the longitudinal direction according to the present invention.

FIG. 7 is an example of a cross-section of an optical fiber cable according to the present invention.

FIG. 8 is an example of a cross-section of an optical fiber cable according to the present invention.

FIG. 9 is an example of a cross-section of an optical fiber cable according to the present invention.

### DESCRIPTION OF EMBODIMENTS

Embodiments of the present disclosure will be described hereinafter in detail with reference to the drawings. By the way, it is to be understood that the present disclosure is not limited to the embodiments described below. The embodiments are merely exemplary and the present disclosure can be implemented in various modified and improved modes based on knowledge of those skilled in the art. Note that, constituent elements with the same reference signs in the present specification and in the drawings represent the same constituent elements.

### EMBODIMENT

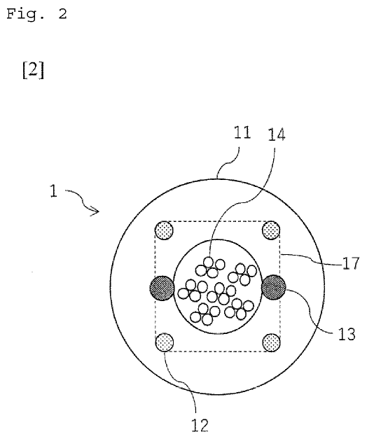

FIG. 2 shows an example of a cross-section perpendicular to a longitudinal direction of an optical fiber cable according to an embodiment of the present invention. 1 denotes an optical fiber cable, 11 denotes a sheath, 12 denotes an anti-tension member, 13 denotes a tear string, 14 denotes an optical fiber core wire, and 17 denotes an outer circumscribed line.

The optical fiber cable 1 includes the sheath 11, the anti-tension member 12, the tear string 13, and the optical fiber core wire 14.

The sheath 11 covers one or more optical fiber core wires 14. The sheath 11 may directly cover the optical fiber core wires 14, or may cover a whole sheath with which the optical fiber core wires 14 are covered.

The sheath 11 has three or more anti-tension members 12 along the longitudinal of the optical fiber core wires 14, inside. The anti-tension member 12 may be composed of a member such as a steel wire or a fiber reinforced plastic. In the present embodiment, the inside of the sheath 11 refers to a region between the inner periphery and the outer periphery of the sheath 11 in the cross-section of the optical fiber cable 1 shown in FIG. 2.

In the present embodiment, in a cross-section perpendicular to the longitudinal direction of the sheath 11, the periphery of a round corner polygon, formed of the outer positioned of common circumscribed lines each of which connects an outer periphery of one of the three or more anti-tension members 12 with an outer periphery of a neighbor of the adjacent anti-tension members 12, is defined as an outer circumscribed lines 17. In FIG. 2, the outer circumscribed lines 17 of the round corner tetragon is illustrated, but it is not limited thereto.

The outer circumscribed lines 17 are preferably peripheral to the inner periphery of the sheath 11 in the cross-section perpendicular to the longitudinal direction of the sheath 11. Thus, in cutting out the sheath 11 with a cutter or the like, the anti-tension member 12 is exposed prior to the optical fiber core wire 14, so that the optical fiber core wire 14 can be protected.

The part of the outer periphery of the tear string 13 is located outside the outer circumscribed lines 17 in at least certain cross-sections perpendicular to the longitudinal direction of the sheath 11. This is defined as requirement 1. When the part of the outer periphery of the tear string 13 is located outside the outer circumscribed lines 17 in all cross-sections perpendicular to the longitudinal direction of the sheath 11, the tear string 13 can be exposed in cutting out the sheath 11, with a cutter or the like, from the tear string 13 side in any cross-section of the sheath 11. On the other hand, when the part of the outer periphery of the tear string 13 is located outside the outer circumscribed lines 17 in only a partial cross-section perpendicular to the longitudinal direction of the sheath 11, in order to expose the tear string 13, the sheath 11 requires cutting out, with a cutter or the like, from the tear string 13 side in the cross-section in which the part of the outer periphery of the tear string 13 is located outside the outer circumscribed lines 17.

Further, the part of the outer periphery of the tear string 13 comes in contact with the inner periphery of the sheath 11 or is located inside the inner periphery of the sheath 11 in the cross-section perpendicular to the longitudinal direction of the sheath 11. This is defined as requirement 2. Preferably, the part of the outer periphery of the tear string 13 comes in contact with the inner periphery of the sheath 11 or is located inside the inner periphery of the sheath 11 in all cross-sections perpendicular to the longitudinal direction of the sheath 11. Thus, the whole of the sheath 11 can be finely cut out by pulling the tear string 13, and the optical fiber core wire 14 can be exposed. Further, the tear string 13 may be located outside the inner periphery of the sheath 11 as long as the whole of the sheath 11 can be finely cut out.

It is desirable that the tear string 13 satisfies the above-mentioned requirements 1 and 2 in at least certain cross-sections perpendicular to the longitudinal direction of the sheath 11. For example, as shown in FIG. 2, the tear string 13 may satisfy both of the requirements 1 and 2, with the tear string 13 located between the two anti-tension members 12. The tear string 13 may satisfy the requirements 1 and 2, respectively, in different cross-sections perpendicular to the longitudinal direction of the sheath 11. Further, the tear string 13 does not always require arranging at two positions, and may be arranged at three or more positions.

A mark, indicating a position for cutting the sheath 11 with a cutter or the like, may be provided on the surface of the sheath 11. For example, when the part of the outer periphery of the tear string 13 is located outside the outer circumscribed lines 17 in only certain cross-sections perpendicular to the longitudinal direction of the sheath 11, by virtue of providing the mark on the outer peripheral part of the sheath 11, of the surface of the sheath 11, in the cross-section in which the part of the outer periphery of the tear string 13 is located outside the outer circumscribed lines 17, the tear string 13 can be exposed more accurately.

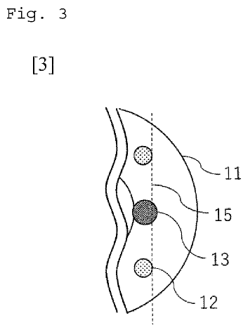

A structure of a tear string 13 of an optical fiber cable 1 will be described with reference to FIGS. 3 to 6.

FIGS. 3 to 5 illustrate examples of a cross-section of the vicinity of the tear string 13 of the optical fiber cable 1. FIGS. 3 to 5 illustrate only a part of the sheath 11 including two anti-tension members 12 and one tear string 13 located between the two anti-tension members 12 in the cross-section perpendicular to the longitudinal direction of the optical fiber cable 1. 15 denotes the outer positioned of common circumscribed lines drawn between anti-tension members 12 neighboring each other, a part of which is shared with circumscribed lines 17. Hereinafter, in FIGS. 3 to 5, the outer circumscribed lines 17 will be described as the common circumscribed line 15 for the purpose of explanation with the tear string 13 and the two anti-tension members 12.

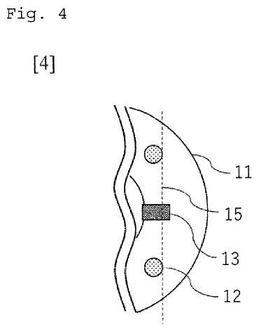

The shape of the tear string 13 can be any shape. For example, a cross-section may be formed into a circle shown in FIG. 3 or a rectangle shown in FIG. 4, one part of an outer periphery may be located outside the common circumscribed line 15 in at least certain cross-sections perpendicular to the longitudinal direction of the sheath 11, and other part of the outer periphery may be arranged so as to be in contact with the inner periphery of the sheath 11 or be located inside the inner periphery of the sheath 11.

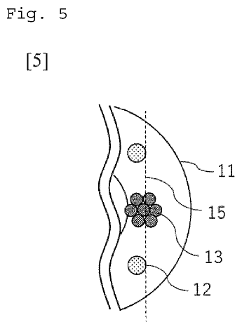

As shown in FIG. 5, the tear string 13 may be composed of a plurality of strings. In this composition, a part of the outer periphery of at least one string of the plurality of strings constituting the tear string 13 may be located outside the common circumscribed line 15, and at least a part of the outer periphery of certain of the plurality of strings may be arranged so as to be in contact with the inner periphery of the sheath 11 or be located inside the inner periphery of the sheath 11.

The tear string 13 may have a structure in which a plurality of strings are twisted together. The tear string 13 may have a structure in which a plurality of strings are braided together. The tear string 13 may have a structure in which a plurality of strings bonded. By virtue of these structures, on taking out at least one of the plurality of tear strings 13, the other tear string 13 can be taken out concurrently.

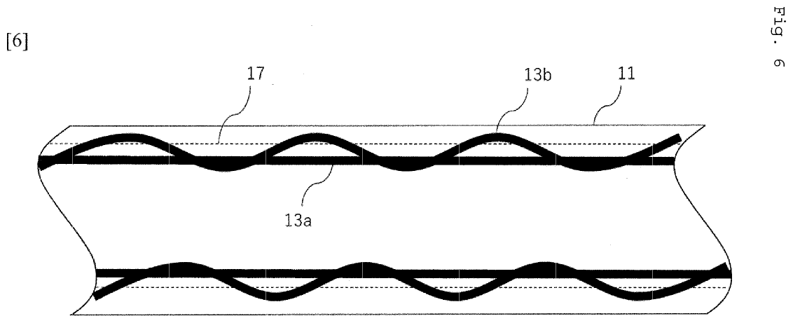

FIG. 6 shows an example of a cross-section along a longitudinal direction of the optical fiber cable 1.

In the tear string 13, at least one string 13a is arranged in a linear, and at least one string 13b is arranged in a wave shape which repeats contact with and separation from the string 13a arranged in the linear (hereinafter, “the string 13a arranged in the linear” is abbreviated as “linear string 13a”); and the string 13b arranged in the wave shape (hereinafter, “the string 13b arranged in the wave shape” is abbreviated as “wave shape string 13b”) has the part which is in contact with the linear string 13a, is adhered or welded, and is located inside the outer circumscribed lines 17, and the part which separates from the linear string 13a and is located outside the outer circumscribed lines 17. In all cross-sections perpendicular to the longitudinal direction of the sheath 11, it is preferable that the part of the outer periphery of the linear string 13a is in contact with the inner periphery of the sheath 11 or is located inside the inner periphery of the sheath 11. It is preferable that an amplitude direction of the wave shape string 13b be a radial direction of the sheath 11.

The tear string 13 composed of the linear string 13a and the wave shape string 13b can be formed of two thin strings 13, and the wave shape string 13b is arranged outside the sheath 11 to be easily pulled out, so that the sheath thickness of the part in which the tear string 13 of the sheath 11 is arranged is not necessary to be thinned, the strength of the optical fiber cable 1 can be maintained. The tear string 13 composed of the linear string 13a and the wave shape string 13b can make the part of the wave shape string 13b exposed prior to the anti-tension member 12 in cutting out the sheath 11 with a cutter or the like, and can make, by pulling out the exposed the wave shape string 13b, the adhered or welded linear string 13a also pulled out concurrently, then the sheath 11 can be divided, and the optical fiber 14 can be easily taken out.

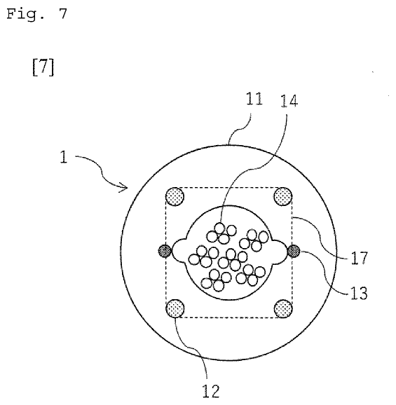

FIGS. 7 to 9 illustrate examples of a cross-section of the optical fiber cable 1 according to the embodiment of the present invention.

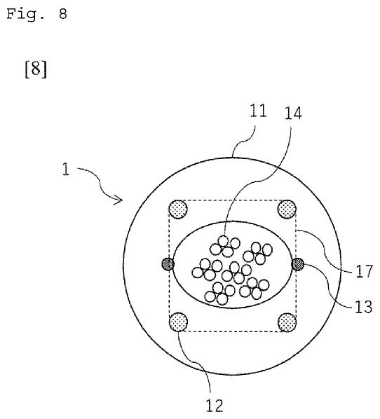

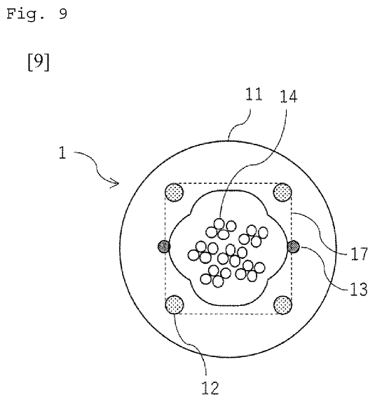

In the sheath 11, the sheath thickness of the part in which the tear string 13 is arranged may be thinner than the sheath thickness of the part in which the tear string 13 is not arranged. For example, as shown in FIG. 7, the inner periphery of the sheath 11 may be an ellipse shape, and the tear strings 13 may be arranged at the tips of the long diameter of the ellipse shape. As shown in FIG. 8, projections may be added to the partial inner periphery with the circular diameter of the sheath 11, and the tear strings 13 may be disposed at tips of the projections separately. As shown in FIG. 9, projections and flat portions having low curvatures may be provided in the inner periphery of the sheath 11, and tear strings 13 may be disposed at tips of the projections separately. Alternatively, the shape of the outer periphery of the sheath 11 may be changed instead of the shape of the inner periphery of the sheath 11. Further, both shapes of the inner periphery of the sheath 11 and the outer periphery of the sheath 11 may be changed.

Note that, even when the shape of the inner periphery or the shape of the outer periphery of the sheath 11 is changed, the conditions of the construction and/or arrangement of the anti-tension member 12 and the tear string 13 are the same as those described above.

By changing the shape of the inner periphery or the shape of the outer periphery of the sheath 11, the optical fiber 14 can be easily taken out without changing the shape of the tear string 13.

According to the optical fiber cable according to the present disclosure, in cutting out the sheath 11 with a cutter or the like, the tear string 13 can be exposed prior to the anti-tension member 12.

### INDUSTRIAL APPLICABILITY

The optical fiber cable according to the present disclosure can be applied to the information communication industry.

### REFERENCE SIGNS LIST

1: Optical fiber cable
11: Sheath
12: Anti-tension member
13: Tear string
14: Optical fiber core wire
15: Common circumscribed line
16: Adhesive portion
17: Outer circumscribed line

1. An optical fiber cable, comprising:
an optical fiber core wire;
a sheath covering the optical fiber core wire;
three or more anti-tension members inside the sheath, arranged along a longitudinal axis of the optical fiber core wire; and
a tear string having an outer periphery a part of which is located outside outer circumscribed lines of outer peripheries of the three or more anti-tension members in certain cross-sections perpendicular to a longitudinal direction of the sheath, and a part of which comes in contact with an inner periphery of the sheath or is located inside the inner periphery of the sheath in a cross-section perpendicular to the longitudinal direction of the sheath.

2. The optical fiber cable according to claim 1, wherein the outer circumscribed lines of the three or more anti-tension members are peripheral to the inner periphery of the sheath.

3. The optical fiber cable according to claim 1, wherein the tear string is composed of a plurality of strings.

4. The optical fiber cable according to claim 3, wherein the tear string has a structure in which the plurality of strings are twisted together.

5. The optical fiber cable according to claim 3, wherein the tear string has a structure in which the plurality of strings are braided together.

6. The optical fiber cable according to claim 3, wherein the tear string has a structure in which the plurality of strings are bonded.

7. The optical fiber cable according to claim 3, wherein the tear string has a structure in which at least one string is linearly arranged, and at least one string is arranged in a wave shape repeating contact with and separation from the string linearly arranged (hereinafter, being abbreviated as “linear string”), and the string arranged in the wave shape has a part, in contact with the linear string, adhered or welded, and located inside the outer circumscribed lines, and a part, separating from the linear string, located outside the outer circumscribed lines.

8. The optical fiber cable according to claim 1, wherein in the sheath, a sheath thickness of a part in which the tear string is arranged is thinner than a sheath thickness of a part in which the tear string is not arranged.
